(19) United States
(12) Patent Application Publication
(10) Pub. No.: US 2017/0232442 A1
(43) Pub. Date: Aug. 17, 2017

(54) PACKAGING, SHIPPING AND STORAGE DEVICE FOR CAPILLARY TUBES

(71) Applicant: NEW OBJECTIVE, INC., Woburn, MA (US)

(72) Inventors: Gary A. VALASKOVIC, Cambridge, MA (US); Lee SAWDEY, Merrimack, NH (US); James M. SELLERS, Portsmouth, NH (US); Haydn B. TAYLOR, Portsmouth, NH (US); Nathan E. WINTERS, Merrimack, NH (US)

(73) Assignee: NEW OBJECTIVE, INC., Woburn, MA (US)

(21) Appl. No.: 15/586,796

(22) Filed: May 4, 2017

Related U.S. Application Data
(63) Continuation of application No. 12/530,946, filed on Oct. 12, 2009, now abandoned.

(51) Int. Cl. B01L 9/06; B65D 85/30; B65D 25/54; B65B 5/08

(52) U.S. Cl. CPC B01L 9/065; B65B 5/08; B65D 85/30; B65D 25/54; B01L 2300/0848; B01L 2300/0609; B01L 2300/123; B01L 2200/025; B01L 2300/0851; B01L 2300/0858; B01L 2300/168; B01L 2200/185; B01L 2300/0838; B01L 2300/0809; B01L 2300/043

(57) ABSTRACT

Capillary tube holder, a storage and shipping container in which a loaded capillary tube holder is securely held, a fixture for loading capillary tubes onto a capillary tube holder and a tube transfer fixture for transferring, removing or replacing individual capillary tubes from a loaded capillary tube holder.

This application is a continuation of U.S. application Ser. No. 12/530,946 filed Oct. 12, 2009, now pending, which is a 371 of PCT/US07/63776 filed Mar. 12, 2007, the contents of which are incorporated herein by reference.

This application pertains to a handling and packaging assembly, or system, for small diameter tubes and rods. It is particularly useful for the handling of small diameter (Outside diameter≦2 mm) tubes that have one end (the proximal end) tapered to a fine tip with the other end (the distal end) square cut. Such tubes find general application in the field of analytical chemistry, and most specifically in the field liquid chromatography-mass spectrometry. These tapered tubes, or needles, are typically used as ionization emitters in electrospray ionization mass spectrometry.

### BACKGROUND OF THE INVENTION

Traditionally capillary tubes or needles have been packaged in one of two ways:
(1) An adhesive material, such as double sided adhesive tape or spray adhesive, is used to affix the tubes in a plastic box; the box typically having a base and flip top lid. The base of the box typically has a raised portion to which the adhesive is applied. The tubes are then placed on the adhesive surface and held by the adhesive for shipping and storage before use.
(2) The tubes are placed individually into a secondary packaging tube that has an inside diameter greater than the outside diameter of the tube being packaged. The secondary tube is then sealed with end caps on each end.

These systems have significant shortcomings. The adhesives used in system (1) may chemically contaminate the tubes being shipped. This is not acceptable for applications in mass spectrometry, a chemical analysis method. Furthermore, the adhesives may deteriorate over time and loose holding power, damaging the tubes being stored.

System (2) is limited in its ability to protect the ends of the capillary tubes since the tubes may shift in the packaging tubes. Contact with at least one end of the capillary tube is typically unavoidable. The typical solution is to affix the distal end of each capillary tube to one of the end caps of the packaging tube, either with an adhesive or by the use of a rubber end cap that has an internal bore having an inside diameter less than the OD of the packaged tube.

A need therefore exists for an assembly which:
(1) is free of any natural or synthetic adhesives, epoxies etc. that could cause chemical contamination of the tubes. More specifically, an assembly which provides a pure mechanical “friction based” holding of the tubes, and
(2) protects the tubes during shipping, especially the tapered ends of the tubes, which cannot withstand any direct physical contact with a surface. Preferably the system avoids contact of either the proximal and distal ends of the tubes with any surface within the package.
(3) allows the end user to remove a single tube at a time from the package without disturbing any other tubes in the package or damaging the tube in any way,
(4) can be produced at cost which is low enough so that the price to the consumer is unchanged, as compared to prior art assemblies. Parts of the system that ship to the customer must be inexpensive enough to be considered disposable while those used in manufacturing are re-usable on at least a limited or extended basis.
(5) meets the physical requirements of manufacturing and quality control, which include:
   a. Ability to load tubes “one-at-a-time” into the assembly.
   b. Ability to remove entire groups of tubes from the assembly and handle them en masse, while maintaining their respective alignment, to expose either the proximal or distal ends for further inspection or processing.
   c. Ability to remove individual tubes that do not meet specifications or pass quality control inspections during manufacturing and replace them with acceptable tubes.

### SUMMARY OF THE INVENTION

In accordance with the invention, there is now provided an assembly/system formed of functional components that provide for the processing, handling, storage, and shipping of groups, or arrays, of tubes. The core of the system is a holder 1 and holding clip 20 that uses a compression element 24 to hold the tubes 90 into the grooves 2 of holder 1. The holder 1 and holding clip 20, including the compressible element 24, and tubes 90, when assembled together, comprise a sub-assembly 15. Various other components and sub-assemblies interface with the combined holder 1, holding clip 20, and tubes 90. Different outside diameter tubes may be accommodated by either adjusting the depth of the grooves 2, the amount of compression applied by the element 24 or both. The compression element 24 is preferably a rectangular section of an elastomeric material, such as rubber, that is held normal to the top surface 3 of 1holder 1.

A loading system comprised of an alignment fixture 30, loading mount 40 and loading clip 50 enables the loading of a holder 1 and holding clip 20 with a population of tubes 90. The design of the loading system enables the loading of individual tubes onto the holder, the application of the holding clip 20 once the holder 1 is populated, and the subsequent removal of the combined holder 1, holding clip 20, and tubes 90 from the loading system. Loading clip 50 has a compression element 54 that is similar in form and substance to the compression element 24 used in the holding clip 20. However the mounting scheme for compression element 54 differs in that the compression element 54, which is preferably a piece of rectangular elastomeric sheet, such as rubber, is held at an acute angle with respect to the top surface 3 of the holder 1.

There is also provided a carrier transfer system which enables handling and processing operations to be carried out on the distal ends 93 of the tubes 90. The carrier transfer system allows the group of tubes 90 to be removed from the holder 1 and holding clip 20 while maintaining their respective alignment in an array. The carrier transfer system comprises a carrier body 60 and carrier clip 70. The carrier body 60 interfaces to the holder 1 and holding clip 20 in a reversible manner so that the group of tubes 90 may be released from the holder 1 and holding clip 20 or transferred to an empty holder 1 and holding clip 20. The transfer clip 70 is designed to protect the proximal end of the tube. It contains a compression element 74, which is similar in form and substance to compression elements 24 and 54, that is held normal to the surface 3 of holder 1.

Finally a package suitable for long-term storage and shipping of the holder 1, holding clip 20, and tubes 90 assembly, i.e., sub-assembly 15, is provided, so that the sub-assembly 15 may be placed directly into the package without the need to individually handle tubes. The package is designed to accommodate tubes that are either shorter in length than the holder 1 or longer than the holder 1 body.

### BRIEF DESCRIPTION OF THE DRAWINGS:

FIG. 1 illustrates an empty holder body, tubes to be loaded onto the holder body and a holder clip to hold the loaded tubes onto the holder body.

FIG. 2 illustrates a bottom view of the tube holder and holder clip, with optional securing rod 26.

FIG. 3 illustrates a holder clip and elastomeric insert (a compression element) to be inserted into a recessed slot on the bottom of the holder clip body.

FIG. 4 illustrates the holder body with capillary tubes loaded thereon and held in place by the holder clip, and the mating elements of the holder clip arms engaged with the corresponding mating elements on the holder body. The loaded holder body, with engaged holder clip constitute sub-assembly 15.

FIG. 5 illustrates a loading fixture assembly comprising alignment fixture 30, loading mount 40, and loading clip 50 together with a loaded holder body 1 and holding clip 20.

FIG. 6A is a detailed view of loading clip 50, illustrating magnets 53, elastomeric insert 54, pressure clamp 52 and tightening screws 51.

FIG. 6B is an exploded side view of angled face 55 of loading clip 50, elastomeric insert 54 (compression element), pressure clamp 52, magnet 53 and tightening screws 51.

FIG. 7 illustrates the loading fixture assembly with loaded holder body mounted thereon.

FIG. 8 illustrates a capillary tube 91, having a tapered proximal end 94 and square-cut distal end 93, being loaded onto holder body 1 through the use of the loading fixture assembly of FIG. 5.

FIG. 9 illustrates holding clip 20 being installed onto the loaded holder body 1, prior to removing the holder body from the loading fixture assembly.

FIG. 10 illustrates the loading fixture assembly, with loaded holder body thereon, as illustrated in FIG. 9, but with loading clip 50 removed.

FIG. 11A illustrates transfer carrier body 60, transfer clip 70 with sub-assembly 15 about to be placed onto the transfer carrier body.

FIG. 11B illustrates a bottom view of transfer clip 70 with elastomeric insert 74 (compression element) to be inserted into recessed slot 77

FIG. 11C is an enlarged cut-away view of the carrier body (60) as depicted in FIG. 11A, with the end where the grooves are located being magnified

FIG. 12A illustrates sub-assembly 15 mounted in the transfer carrier body.

FIG. 12B is a frontal view of the carrier body with sub-assembly 15 mounted on, showing the stepped down top surface at the front of the carrier body, spaced away from the proximal ends of the tubes thereby avoiding contact of the proximal ends of the tubes with the surface of the carrier body.

FIG. 13 illustrates sub-assembly 15 mounted in the transfer carrier body with transfer clip 70 placed over the loaded capillary tubes to hold them onto the transfer carrier body and, at the same time, cover and protect the proximal ends of the tubes.

FIG. 14 illustrates sub-assembly 15 mounted in the transfer carrier body with transfer clip 70 in place, with the holding clip 20 and the holder body 1 removed, to form sub-assembly 76.

FIG. 15 illustrates a loaded sub-assembly 15 in juxtaposition with shipping sub-assembly 85.

FIG. 16 illustrates sub-assembly 15 secured within shipping sub-assembly 85.

FIG. 17 illustrates a loaded sub-assembly 15 with extended length tubes 92, in juxtaposition with shipping sub-assembly 85.

FIG. 18 illustrates sub-assembly 15 with extended length tubes secured within shipping assembly 15, with the loaded tubes projecting into the rear storage area of the shipping sub-assembly.

FIG. 19 illustrates the loaded shipping sub-assembly in closed position, suitable for shipping or storage.

### DETAILED DESCRIPTION

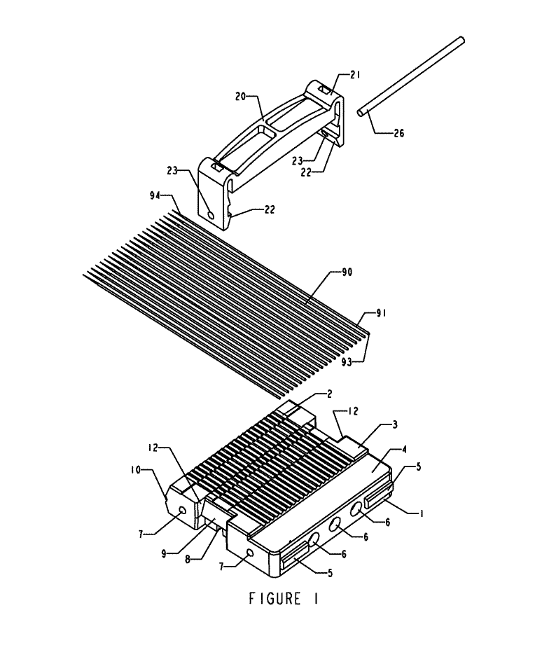

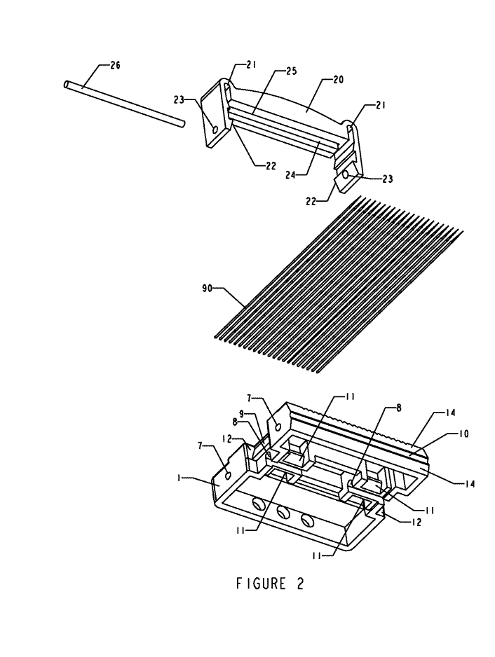

FIGS. 1 and 2 show the core components of the system, a holder body 1, the group of tubes that are being handled 90, and the holding clip 20 that holds the tubes 90 in place. A group of tubes 90 consists of individual tubes 91 each of which has a front (proximal) end 94 and rear (distal) end 93. Typically the front end 94 is tapered to a fine tip and the rear end 93 is square cut. Holder body 1 has a combination of features that enable it to meet the requirements outlined above. As seen, holder body 1 has a front side, a rear side having holes 6, two flank sides, a bottom surface and a top surface 3. There are parallel grooves 2, which preferably are V shaped grooves, in the top surface 3 of the holder body that are parallel to the surface. There is a recessed top surface 4 that is lower than the deepest part of the groove 2 at the rear section of the holder. The recessed portion 4 allows individual tubes to be handled from the rear.

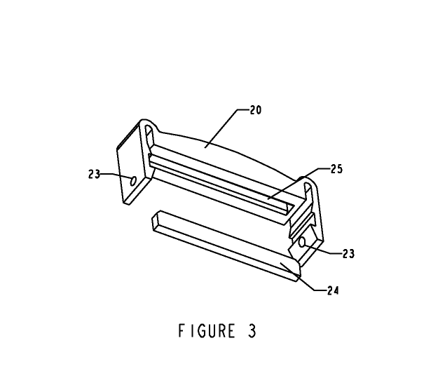

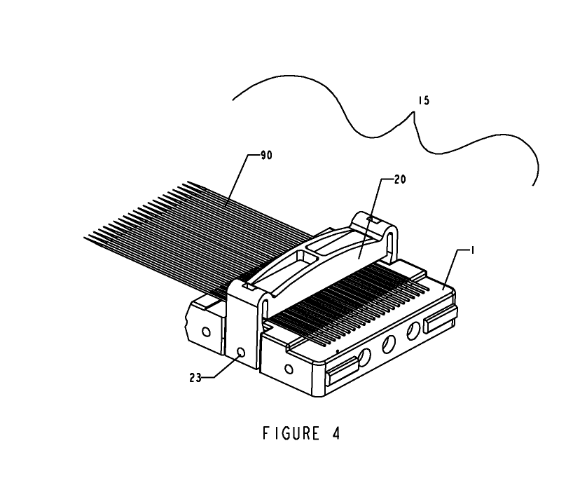

Holding clip 20 has two protruding side arms 21, which are terminated by tapered mating elements 22 that mate with complementary tapered mating elements 9 on the flank sides of holder body 1. The tapered mating elements 9 on the flank sides of holder body 1 are disposed perpendicularly from the top surface and taper increasingly further away from the flank sides along the direction from the top surface towards the bottom surface. The distance between the two respective side arms 21 is set so that the clip has a direct positive engagement with the holder body 1, resulting in what is commonly referred to as a snap-fit. As the holding clip 20 is forced into place the arms 21 deflect as the faces of elements 9 and 22 make contact. Each side arm 21 aligns with the recessed slots 12 in the two flank sides of the holder body 1. As shown in FIG. 3, elastomeric insert 24 (a compression element) fits into recessed slot 25 on the underside of holding clip 20. The elastomeric insert 24 is preferably made with a rectangular cross section, and can be made of Viton®, a fluoroelastomer available from DuPont Performance Elastomers LLC, Buna N rubber (a Nitrile rubber), Teflon® polytetrafluoroethylene available from E.I. DuPont De Nemours and Company Corporation, or platinum cured silicone rubber; preferably Viton® or silicon rubber, most preferably silicone rubber. The relative hardness of the elastomeric insert is preferably within the range of 20 to 80, and most preferably within the range of 45 to 55, as measured by a Shore A Durometer. Therefore the most preferred elastomer insert is a platinum cured silicone rubber having a Shore A hardness greater than 45 and less than 55. The slot 25 is perpendicular to the top face 3 of holder body 1 when the holding clip 20 is engaged. Thus the end face of elastomeric insert 24 makes perpendicular contact with the tubes 90. The assembled combination of the holder body 1, holding clip 20, compressive element 24 and tubes 90 comprises sub-assembly 15, as illustrated in FIG. 4.

The amount of static (and dynamic) holding force is readily controlled by either changing the relative hardness of the elastomeric insert 24; and/or by altering the dimensions of the insert. Using an insert made from a higher durometer material will increase the holding force because the amount of reactive force generated by compressing the insert increases. Similarly making the elastomeric insert either thicker or taller will increase the holding force. Increasing the thickness of the insert increases the contact surface area of the elastomeric insert 24 with the tubes 90, hence the holding force will increase. By increasing the height of the elastomeric insert 24, the amount of elastomer that protrudes out of the slot 25 will increase. The holding force on tubes 90 will increase since the compression of the elastomeric insert 24 will be greater, creating a larger reactive holding force on the tubes 90. The thickness of the elastomeric insert may be within the range of 0.5 to 10 mm, preferably within the range of 1 to 5 mm, and most preferably within the range of 1.5 to 2 mm. The thickness of the elastomeric insert 24 and the height protruding from slot 25 is determined empirically so that a pull test of tubes 90 being held in subassembly 15 will yield a number within the preferred range for static and dynamic holding force. Changing the diameter of the tubes 90 will require a change in either hardness or dimension of elastomeric insert 24. Most conveniently the height of elastomeric insert 24 may be changed to bring the holding force within the desired range.

The holder body 1 optionally includes a slot 8 transverse to its bottom surface and holding clip 20 optionally includes holes 23 in each of the two side arms 21 which align with slot 8 when the clip is engaged with the holder body. Optional rod 26 may then be inserted through the holes 23 and under the holder body, via the slot 8, to further secure the holding clip 20 to holder body 1. The holder body 1 optionally includes through holes 6, in between protrusions 5, running parallel to the top face 3. The holes 6 can be used to hold or mount the holder body 1 on one or more mating cylindrical rods; or to manipulate holder body 1 using hand tools such as needle-nose pliers or forceps.

FIG. 4 shows the holder body 1, tubes 90 and holding clip 20 when fitted together to form an assembled group of tubes. The sides of holding clip 20 are flush with the side of holder body 1. The tubes 90 are held in place between the elastomeric insert (compression element) 24 and the grooves 2. The holding force applied to tubes 90 is determined by the amount of static and dynamic friction between tubes 90 and groove 2 and tubes 90 and elastomeric insert 24. When holding clip 20 is pressed in place on holder 1, the elastomeric insert 24 is slightly compressed. The reactive holding force that keeps the assembly together is provided by the mating elements 22 on holding clip 20 and complementary tapered mating elements 9 on holder body 1. The securing rod 26 is not shown in this illustration, but could be used, if desired, to further secure the assembly by being inserted into one of holes 23 on the first side arm 21 of clip 20, across the bottom of holder body 1 and into the second hole 23 on the second side arm 21 of clip 20.

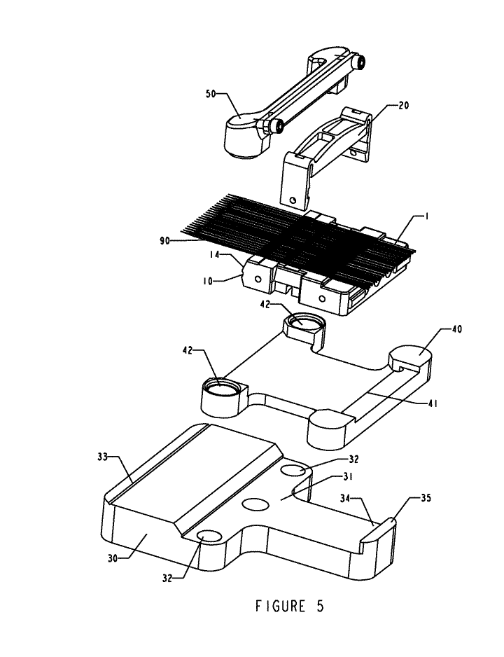

To load, or “populate”, holder body 1 with the array of tubes 90, the loading fixture assembly of FIG. 5 is employed. This fixture assembly provides for loading the holder body 1 one tube at a time, either by hand or by an automated handling system. In addition to the holding clip 20 and holder 1 body, the loading assembly includes alignment fixture 30, loading mount 40, and loading clip 50. Loading mount 40 is held in place on alignment fixture 30 by means of complementary magnets, 32 in the alignment fixture and 42 in the loading mount.

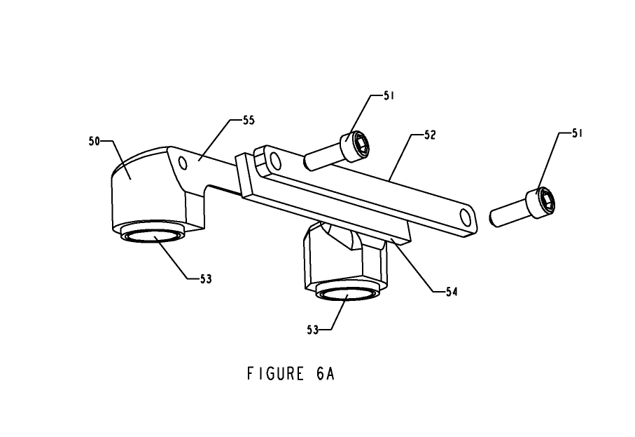

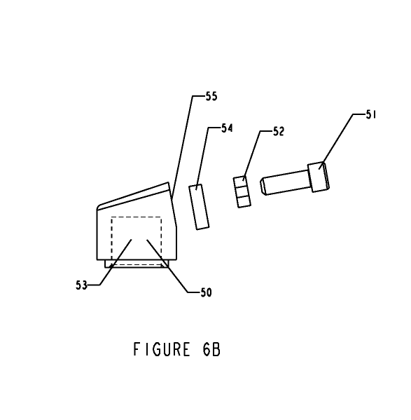

FIGS. 6A and 6B show the loading clip 50 in detail. Magnets 53 in the protruding side arms of the loading clip 50 mate with the magnets 42 in the loading mount 40. An elastomeric insert (compression element) 54, is held in place by a pressure clamp 52 that is mounted to the loading clip 50, preferably by means of ordinary machine screws 51. Loading clip 50 has an acutely angled surface 55, best seen in FIG. 6B, with respect to the plane of top surface 3 when assembled, so that rubber insert 54 is held at an acute angle with respect to the top surface 3 of holder body 1. This acute angle provides for low friction insertion of the distal end 93 of singe tube 91 into a groove 2 on holder body 1. This acute angle with respect to top surface 3 of holder 1 is preferably within the range of 45° to 85°, more preferably within the range of 65° to 85°, and most preferably within the range of 75° to 80°.

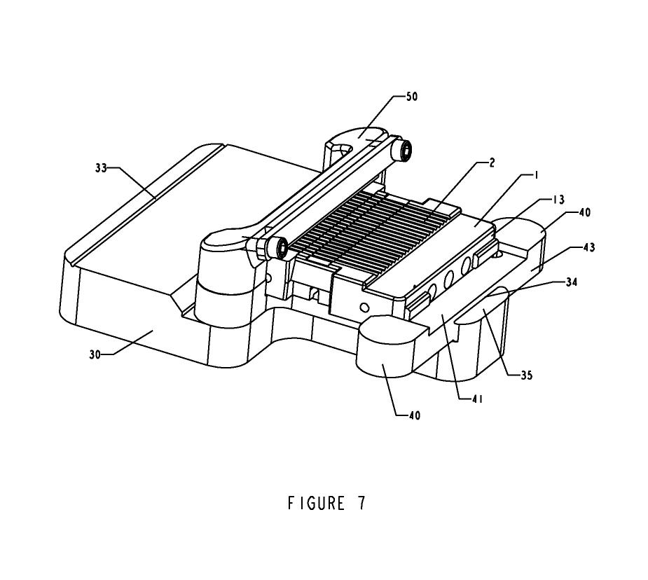

The initial assembly to populate a holder body 1 with tubes is shown in FIG. 7. Loading mount 40 is placed on alignment fixture 30 so that the rear face 43 of loading mount 40 is in contact with the front face 34 of protrusion 35 on alignment fixture 30. The complementary magnet pairs 32 and 42 in the alignment fixture 30 and loading mount 40 hold the two components together. Holder body 1 is placed on loading mount 40 so that the rear face 13 is in contact with the stepped edge 41 on loading mount 40. Loading clip 50 holds the holder body 1 in place on the mount 40 by means of complementary magnets 53 that align with magnets 42 in the loading mount 40.

The angled nature of the contact between elastomeric insert 54 and the tubes 90 results in the combination of sliding and static friction between the tubes and the elastomeric insert being different when the direction of movement of the tubes, with respect to the front of the mount is changed. The insertion force will be lower for pushing the distal end 93 of tube 91 in between groove 2 and elastomeric insert 54, than for the reverse operation. This characteristic makes the tubes easier to insert into the loading assembly and more difficult to remove. It has been found that these requirements can be met if the force required to initiate movement of the tubes in the assembly and the force necessary to maintain that movement, once initiated, fall within certain ranges.

There are two components to these force considerations:
1.) The force necessary to initiate movement of the constrained tube (the static force).
2.) The force necessary for comfortable extraction such that the process is smooth, homogenous and normalized across all grooves (the dynamic force).

The force required to initiate movement (the static force) of the tubes into the loading fixture assembly should be less than 1 N (Newton), preferably between 0.04 to 0.5 N, and the force required to maintain movement of the tubes into the loading fixture (dynamic force) should preferably be from less than 0.04 N up to about 0.2 N.

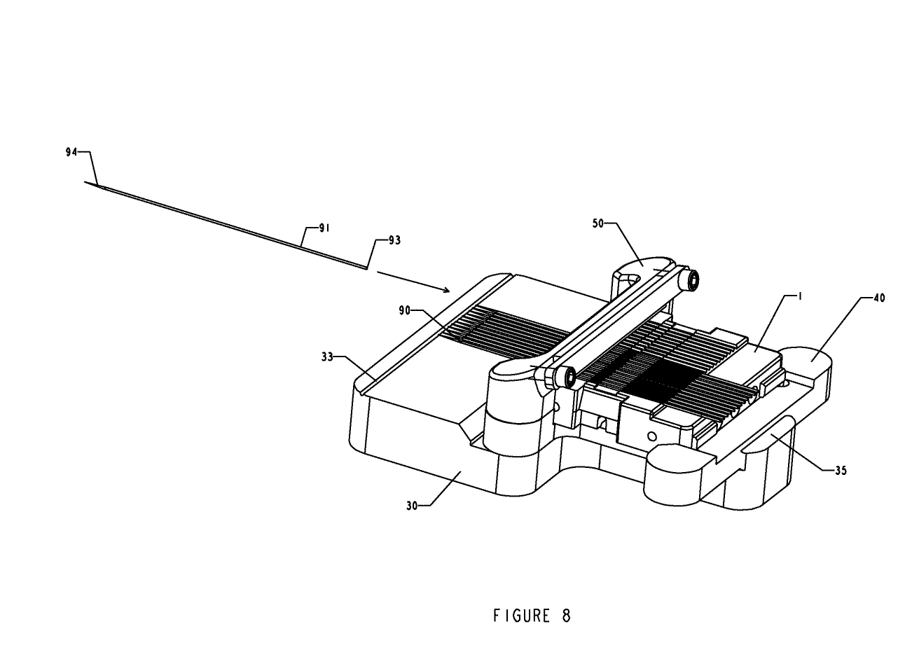

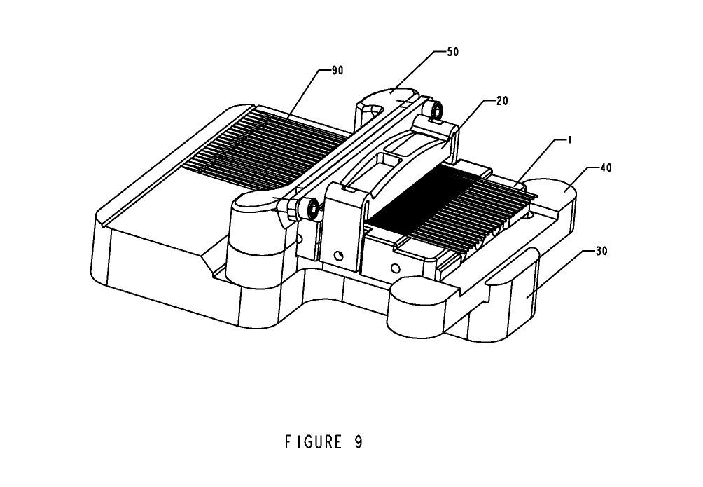

FIG. 8 illustrates the population of individual tubes 91 into the loading assembly comprised of the alignment fixture 30, loading mount 40, holder body 1, and loading clip 50. The distal end 93 of tube 91 is inserted between the groove 2 and angled elastomeric insert 54. The tube 91 is pushed toward the rear of the holder body 1 until the proximal end 94 is in alignment with fiducial mark 33 on alignment fixture 30. This operation is then repeated until the desired number of tubes are loaded onto holder body 1. Holding clip 20 is then inserted, i.e., snap fitted, onto holder body 1, so that the elastomeric insert (compression element) 24 is compressed against the tubes 90 in grooves 2. The tubes are then held in place by the friction between the tubes and compression element 24, as shown in FIG. 9.

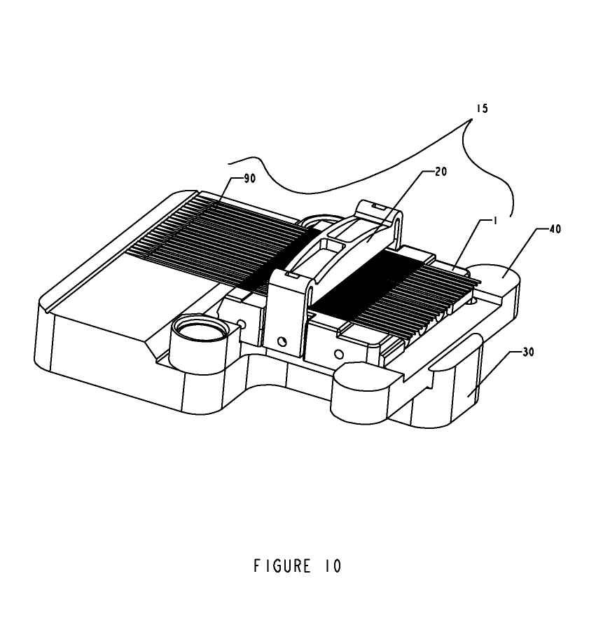

In accordance with the foregoing procedure, once the holder body 1 is fully populated with tubes 90, the (temporary) loading clip 50 may be replaced with the standard holding clip 20. FIG. 9 shows the grooves 2 in holder body 1 fully populated by tubes with holding clip 20 in place just behind the loading clip 50. Once holding clip 20 is in place the tubes are secure and the loading clip 50 may then be removed as shown in FIG. 10. The loaded sub-assembly 15, made-up of holder body 1, tubes 90, compression element 24, and holding clip 20 may then be removed from the loading mount 40 for further handling operations or packaging.

To insure maximum utility of the holder clip sub-assembly 15 as a multi purpose manufacturing process fixture and final packaging and presentation element, functional and ergonomic factors should be considered Environmental effects which may be encountered during shipping and handling should also be taken into consideration, in order to assure survivability during shipping and handling. With respect to the functional effects, the tubes 90 should be rigidly held in their respective grooves 2 and their alignment, especially the alignment of their ends, should be maintained as the sub-assembly 15 travels through a range of manufacturing processes, during which the sub-assembly 15 is exposed to a variety of shocks, vibrations, and inertial forces.

Ergonomically, the size of sub-assembly 15 should be as compact as possible yet still addressable with a normal hand and finger size for ease of placement and manipulation of the capillary tubes during processing. Additionally, once assembled into the final packaging and shipped to the customer for use, it is important that the tubes 90 are able to be easily and efficiently extracted in serial fashion from either a right or left handed approach. All three elements of the clip holder sub-assembly 15 should be constructed to give the end user a comfortable and successful experience such that the human/device failure modes are minimized. It has been found that these requirements can be met if the force required to initiate movement of the tubes in the assembly and the force necessary to maintain that movement, once initiated, fall within certain ranges.

A preferred range of tensile force required (static force) to initiate tube movement (or conversely prevent movement) in the holder assembly 15 was found to be 0.04-3.0 N, preferably 1.0-1.6 N. A preferred range of tensile force (dynamic force) to maintain movement, once initiated, was found to be 0.04-2.8 N, preferably 0.8-1.4 N.

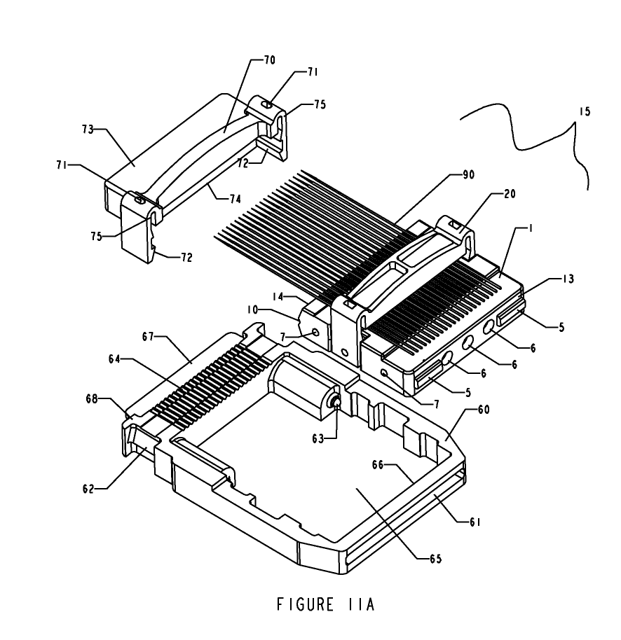

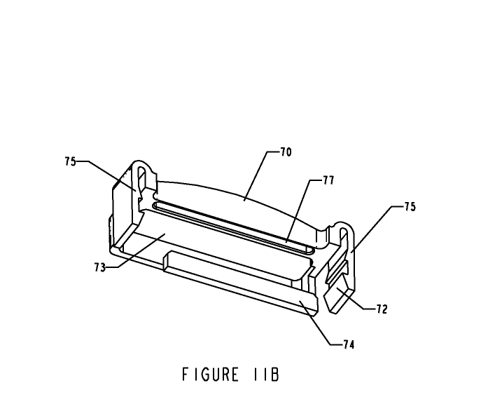

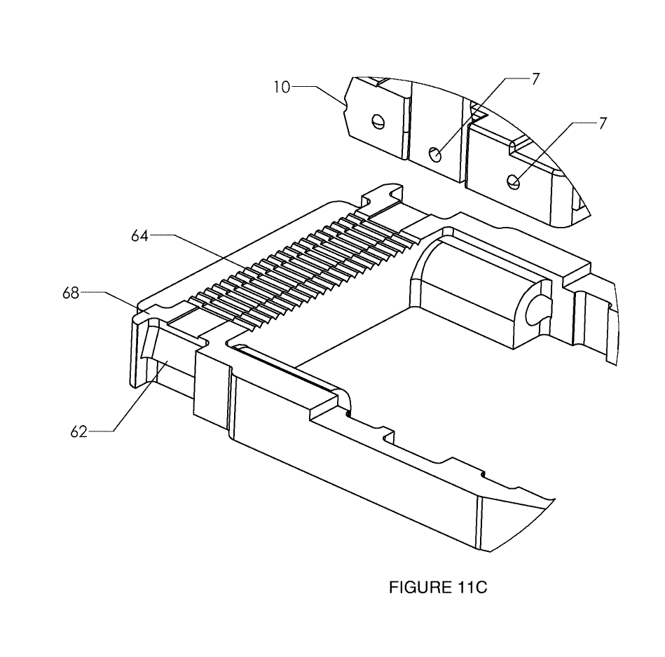

FIG. 11A shows the transfer carrier body 60, the carrier clip 70, and the tube-clip-holder sub-assembly 15. Carrier body 60 has elements deigned to interface with holder body 1. A slot 61 through the rear face of the transfer carrier body 60 has an internal width that is slightly larger than the width of the rectangular protrusions 5 on the rear face of the holder body 1. Securing elements in the form of spring loaded compressive elements 63, commonly referred to as spring loaded pins, interface into the detent 10 on the front face of the holder body 1. The combination of these elements enables sub-assembly 15 to be fitted into the mating cavity 65 in the carrier body 60. Cavity 65 is configured to receive holder body 1 and temporarily secure it in place through cooperation of spring-loaded pins 63, detent 10, protrusions 5 and slot 61, and has sufficient interior clearance so that the holder body 1 and mating holding clip 20 can pass through said cavity upon the application of sufficient force to overcome the holding force of the spring-loaded pins.

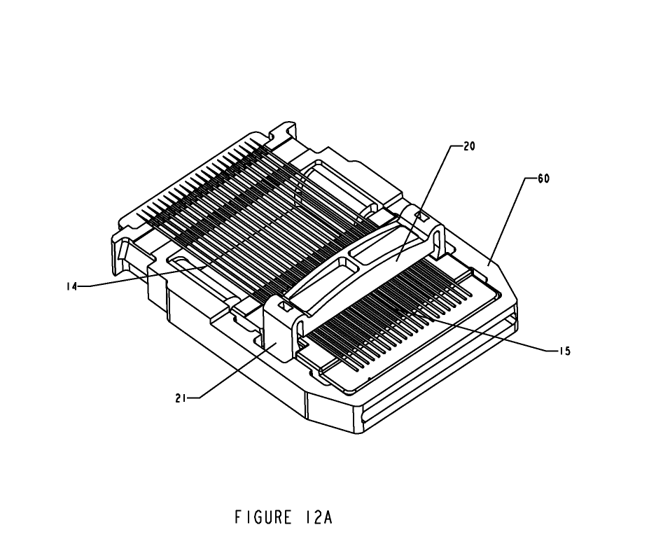

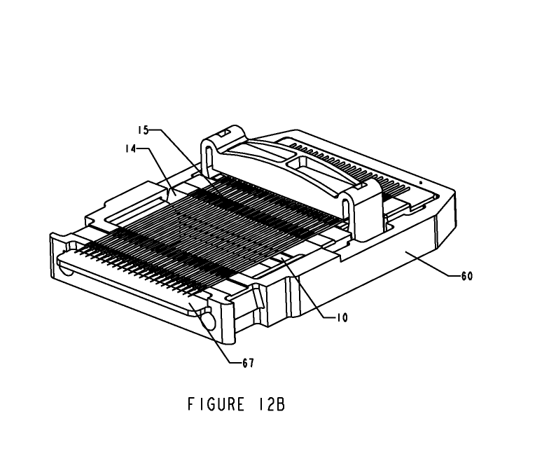

Carrier body 60 has additional features for holding of the tubes 90. A set of grooves 64 in top face 68 have two open ends at top face 68 and identical shape, spacing and depth as the grooves 2 found in the holder body 1. In front of the grooves at the leading part of carrier body 60 there is a stepped-down top face 67 (best seen in FIG. 12B). Mating elements 62, similar to elements 9 on the holder body 1, are placed on the front ends of the sides of carrier body 60.

A carrier clip 70 has two side arms 75 that each have complementary mating elements 72 that mate with elements 62 on the carrier body 60. The spacing and shape between elements 72 is set so that the carrier clip 70 may be clipped into place on carrier body 60 in a manner completely analogous to that of the action of holding clip 20 on holder body 1. The bottom of carrier clip 70 is shown in FIG. 11B. A compression element, such as elastomeric insert 74 fits into recessed groove 77 in a manner completely analogous to the compression element/elastomeric insert 24 fitting into the groove 25 of holding clip 20. The composition, dimensions, action, static and dynamic holding force on the tubes 90 provided by elastomeric insert 74 in carrier clip 70 is completely analogous to that provided by elastomeric insert 24 in holding clip 20.

Insertion proceeds by first aligning the holder protrusions 5 parallel with the slot 61, holding the sub-assembly 15 at an acute angle with respect to the carrier body. Rear face 13 is pressed into contact with the rear face 66 of cavity 65, while ensuring that protrusions 5 are aligned to fit into the slot 61. Once in position, the angle between the sub-assembly 15 and carrier body 60 is reduced by rotating sub-assembly 15 through an axis defined by the contact of mating elements, 5 and 61, and, 13 and 66, until the compressive elements 63 make contact with the front face 14 of the holder body 1. The alignment between the holder body 1 and carrier body 60 is then made parallel when the compressive element 63 makes positive engagement with the detent 10 on the front face 14 of holder body 1 as shown in FIG. 12.

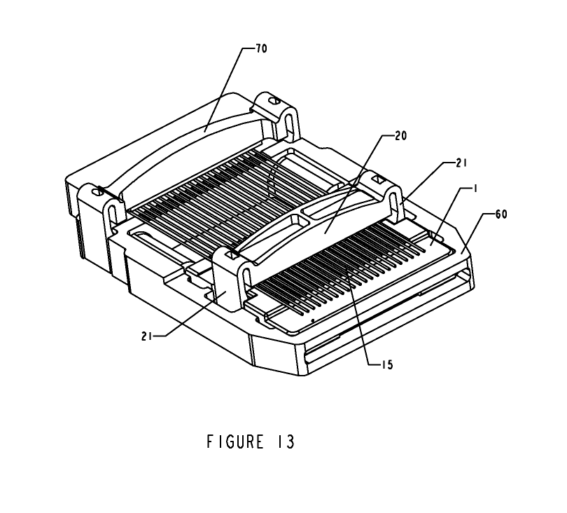

FIG. 12A shows sub-assembly 15 in position for transfer or replacement of the tubes 90. FIG. 12B shows a frontal view of the subassembly 15 on carrier body 60. To complete the transfer, carrier clip 70 is applied to the carrier body as shown in FIG. 13. elastomeric insert 74 presses the tubes into the grooves 64.

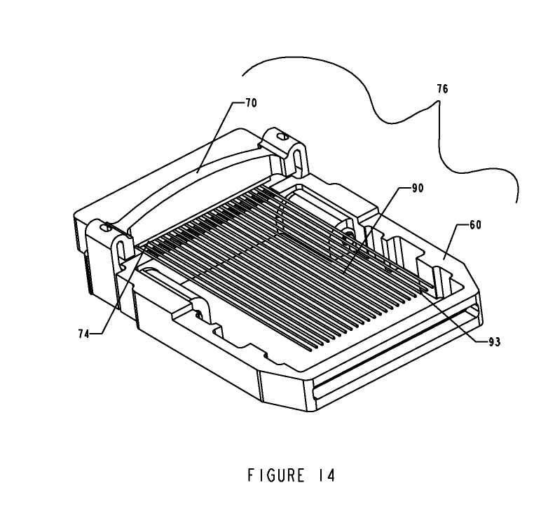

At this stage the tubes are held in place by clips 70 and 20 simultaneously. Holding clip 20 may then be released by bending the side arms 21 sufficiently outward so that mating elements 22 and 9 are no longer in contact. Holding clip 20 can then be removed. The holder body 1 is then removed through the bottom of the assembly by pushing said holder body 1 through the cavity 65 so that the compressive elements (spring-loaded clips 63) release from the detent 10 on the front face 14 of holder body 1. Removal through the bottom of the assembly leaves the tubes 90 undisturbed. The resulting arrangement of the tubes 90, carrier body 60, carrier clip 70 and elastomeric insert 74 is shown in FIG. 14, comprising sub-assembly 76. The distal ends 93 of the tubes 90 are now exposed for processing, inspection or removal of individual tubes for further use, and the proximal ends 91 are fully protected by the shield 73 on clip 70.

The action of the carrier assembly is fully reversible so that tubes 90 in sub assembly 76 may be transferred back to sub assembly 15 by reversing the steps as described above.

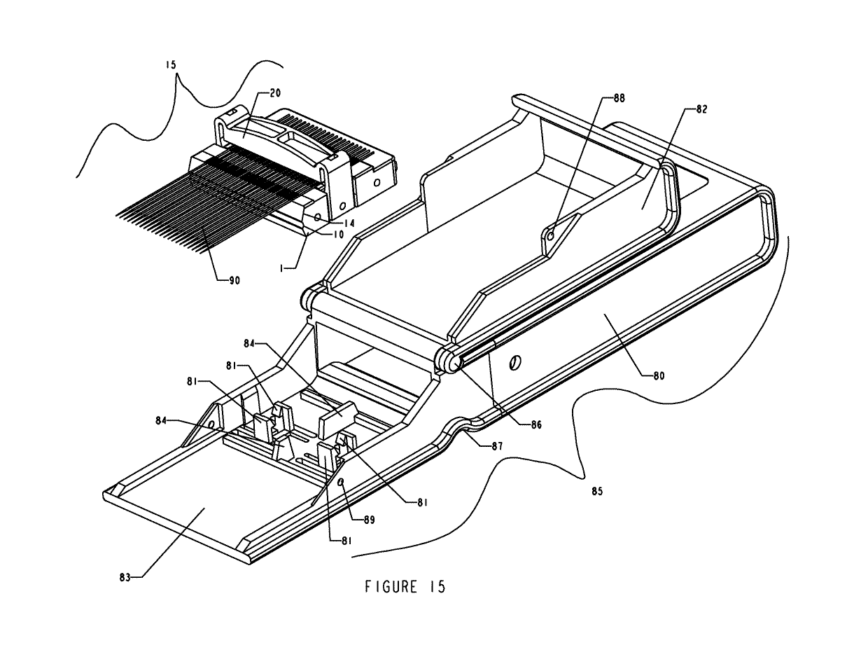

For packaging storage and shipping sub-assembly 15 fits into sub assembly 85. Sub assembly 85 is a hinged box having a top wall, a bottom wall, two side walls, a front end and a rear wall which define the interior of the box. The box comprises a rear housing section 80, a front section 83 and a hinged lid 82, comprising a part of the top wall, as shown in FIG. 15. Rear housing section 80 attaches to the front section 83 through any conventional means including snap-fit, adhesives, screws, solvent welding, or ultrasonic welding. Lid 82 is attached to front section 83 via a snap fit hinge 86 well known to those skilled in the art of plastic hinged boxes.

Hinged lid 82 is preferably transparent.

Preferably, between the hinges of said hinged lid 82 and the front side of box 85, the side walls are each comprised of two sections; a first section extending from the bottom surface of the box and a second section extending from the hinged lid, the two sections meeting each other to form a closed wall upon closure of the hinged lid.

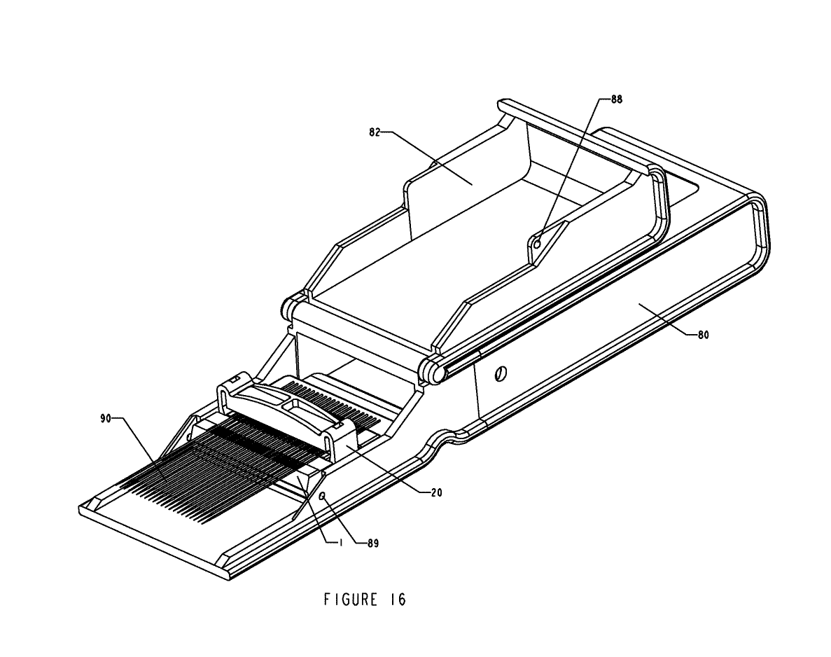

Front section 83 has mating elements 81, which are snap-fit elements that engage with complementary elements 11 on holder body 1 (illustrated in FIG. 2). Sub-assembly 15 is pressed down onto mating elements 81 as shown in FIG. 16. Protrusions 84 guide the alignment of the underside of holder body 1 so that the complementary mating elements 11 align with and are engaged by snap-fit mating elements 81 on the surface of front section 83. Elements 81 are flexible in the plane perpendicular to the rear face of holder body 1 so that they are deflected by elements 11 when pressure is applied, normal to surface 3, to sub-assembly 15. When fully engaged, elements 81 and 11 secure sub-assembly 15 in place on the surface of front section 83 within box 85, in the manner of a snap fit, well known to those skilled in the art.

The lid 82 is integral with the front wall of the box and has bumps 88 that mate with complementary holes 89 on the side walls of front platform 83 as shown in FIG. 16. When the lid is moved to the closed position the side walls of the lid 82 and platform 83 deform slightly until the bumps 88 are coincident with the holes 89. These complementary features hold the lid in closed position to protect the tubes within, until opened by the ultimate user to access the tubes.

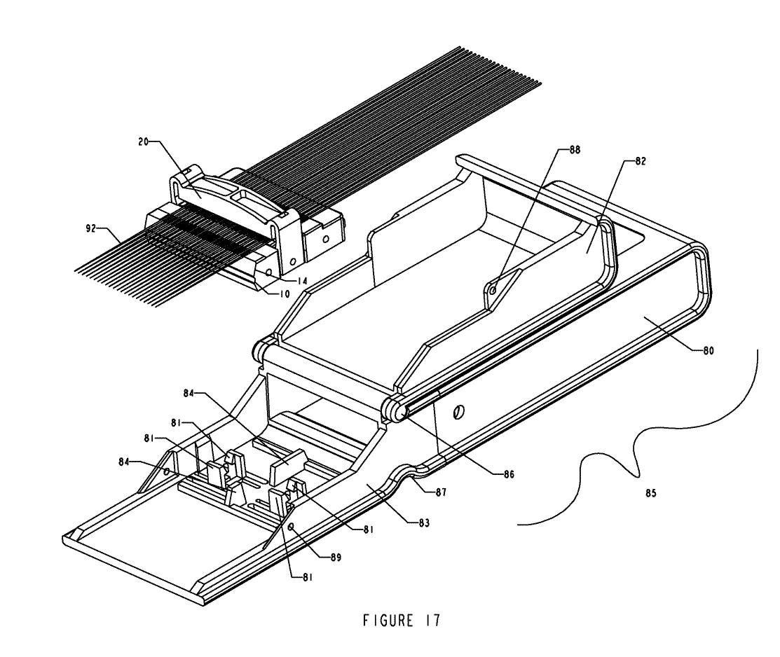

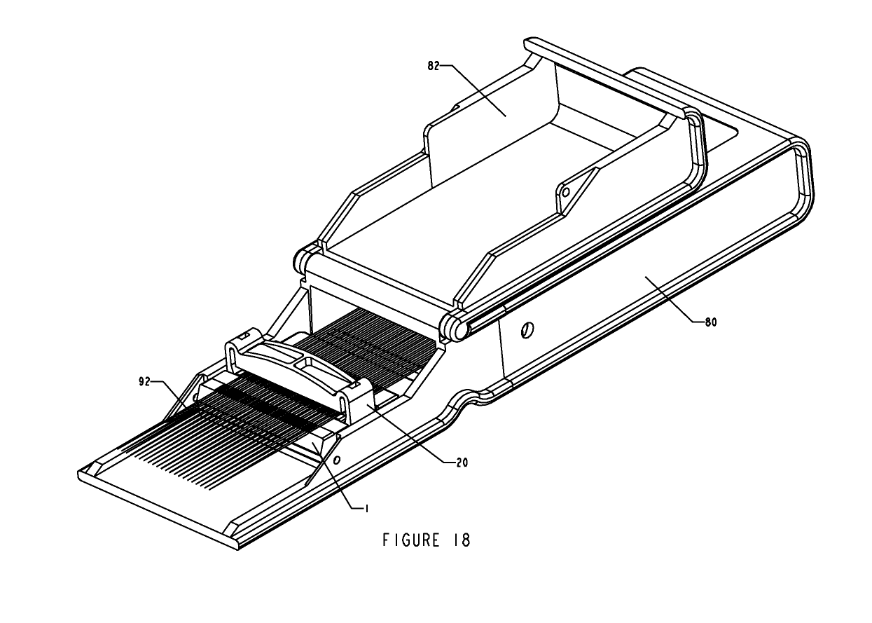

FIGS. 17 and 18 illustrate rear housing 80, which is hollow inside to accommodate tubes 92, having a length that extends beyond the rear surface 13 of holder body 1. Such tubes are shown mounted on the holder body in FIG. 17. FIG. 18 shows the loaded holder body of FIG. 17 installed in the sub-assembly (box) 85 for storage and/or shipment.

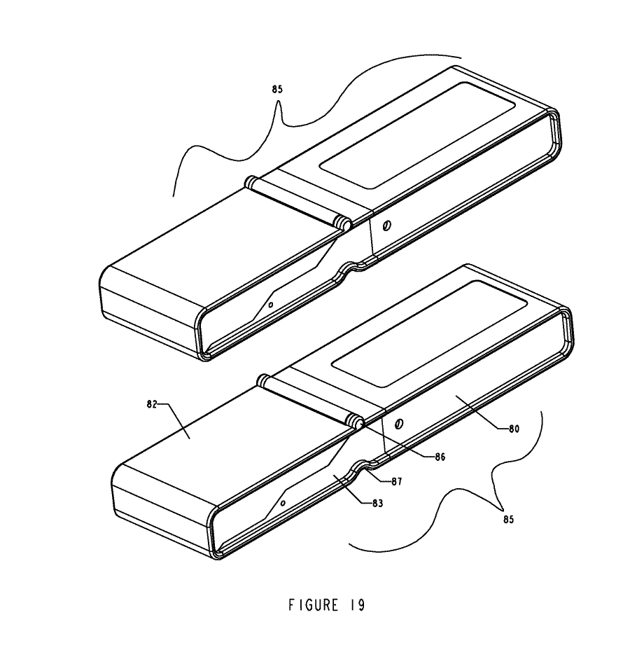

FIG. 19 illustrates indentation 87 on the bottom surface of sub-assembly/box 85 which runs parallel to the hinge 86. This allows for the ready stacking of closed boxes 85 on top of each other. The depth of the indentation is complementary to the height of the hinge 86 to allow for even balanced stacking of boxes.

While the present invention was shown and described with reference to the preferred embodiments, various modifications will be apparent to those skilled in the art and, therefore, it is not intended that the invention be limited to the disclosed embodiment and/or details thereof, and departures can be made therefore within the spirit and scope of appended claims.

| | Element | |
|---|---|---|
| Assembly | Number | Description |
| holder | 1 | holder |
| | 2 | plurality (linear array) of grooves in top surface 2 |
| | 3 | top surface of holder |
| | 4 | recessed top surface of holder |
| | 5 | rectangular protrusion on rear surface 13 of |
| | | holder |
| | 6 | Hole(s) on rear of holder |
| | 7 | bump on side of holder |
| | 8 | Slot through base of holder, parallel to front face |
| | | of holder |
| | 9 | mating feature on side of holder to interface with |
| | | clip |
| | 10 | cylindrically indented surface on front face of |
| | | holder |
| | 11 | mating feature on underside of holder body |
| | 12 | recessed portions on side of holder body to allow |
| | | clip engagement |
| | 13 | Rear face of holder body 1 |
| | 14 | front face of holder body 1 |
| | 15 | combined holder 1, compressive element 24, clip |
| | | 20, and tubes 90 |
| holding clip | 20 | holding clip |
| | 21 | Side arm of clip |
| | 22 | mating feature on side arm to hold clip onto |
| | | holder |
| | 23 | Hole through side arm of clip, parallel to clip |
| | | body, aligned to slot feature 8 |
| | 24 | compression element normal to the top surface |
| | | 3 of holder 1 |
| | 25 | recessed slot for compression element 24 |
| | 26 | optional locking rod |
| alignment fixture | 30 | alignment fixture |
| | 31 | recession in top surface of fixture |
| | 32 | magnet flush with recessed top surface 31 |
| | 33 | fiducial mark on top surface |
| | 34 | front face of protrusion 35 |
| | 35 | protrusion on rear of fixture |
| loading mount | 40 | loading mount |
| | 41 | recessed top surface on loading mount |
| | 42 | magnet press fit into body of loading mount |
| | 43 | rear face of mount 40 |
| loading clip | 50 | loading clip |
| | 51 | screw holding pressure plate to clip body |
| | 52 | pressure plate |
| | 53 | magnet press fit into clip body |
| | 54 | compression element held at an acute angle |
| | | relative to the top surface of holder 1 |
| | 55 | Angled face on rear side of clip body 50 |
| carrier | 60 | carrier body |
| | 61 | alignment slot in rear face of carrier body, |
| | | accepts the |
| | 62 | mating element on side of carrier, mates with |
| | | feature 72 of carrier clip |
| | 63 | spring loaded alignment pin, mates with |
| | | indented front surface of holder |
| | 64 | plurality (linear array) of grooves in top surface |
| | | of carrier body |
| | 65 | through-cavity |
| | 66 | rear internal face of cavity |
| | 67 | stepped top surface of carrier, below the depth |
| | | of the grooves 64 |
| | 68 | top surface of carrier |
| carrier clip | 70 | carrier clip body |
| | 71 | holder through the top of the carrier clip side arm |
| | 72 | mating feature on side arm of clip that mates |
| | | with feature on carrier body |
| | 73 | shield element of clip that extends past and |
| | | around the forward (leading) edge of the tubes |
| | 74 | compression element |
| | 75 | side arm of carrier clip 70 |
| | 76 | sub-assembly comprising carrier 60, tubes 90, |
| | | clip 70 and compressive element 74 |
| | 77 | recessed slot for compression element 74 |
| box | 80 | rear box housing |
| | 81 | mating feature inside box that mates with |
| | | features 11 on underside of holder |
| | 82 | hinged box lid |
| | 83 | front box platform |
| | 84 | alignment protrusions |
| | 85 | box sub-assembly |
| | 86 | hinge |
| | 87 | indentation to allow for box stacking |
| | 88 | bump on lid |
| | 89 | mating hole in front platform |
| tubes | 90 | plurality (linear array) of tubes whose length |
| | | does not extend past the rear surface of the |
| | | holder body |
| | 91 | single tube |
| | 92 | plurality (linear array) of tubes whose length |
| | | extends past the rear surface of the holder body |
| | 93 | rear end (distal end) of tube |
| | 94 | front end (proximal end) of tube |

We claim:

1. A capillary tube holder comprising
a) a holder body (1) having a front side, a rear side, two flank sides, a bottom surface and a top surface (3), V-shaped linear grooves, no part of which are curved, with two open ends (2) in said top surface (3) and a depression in said top surface at the rear of said body, said depression running from one of said two flank sides to the other, transverse to said grooves, said grooves running parallel to said flank sides beginning at the front of said body and ending at said depression, said depression being lower than the lowest part of said grooves, and mating elements on the flank sides of the holder body
b) a holding clip (20), having a top side, a bottom side, and two ends, two side arms (21) extending at approximately right angles from said bottom side at said ends, said bottom side having a compression element (24) inserted into a corresponding recess in the surface thereof or being adhered to the surface thereof, and extending away from said surface of said bottom side, said holding clip side arms having mating elements (22) at the ends thereof which mating elements are complementary to the mating elements on the flank sides of said holder body, the distance between the legs being adapted to fit over the flank sides of said holder body, with said side arms fitting over said flank sides of said holder body to engage the mating elements of said arms with the mating elements on the flank sides of said holder body to lock said holding clip in place over a grooved section of said top surface of said holder body with said compression element compressed against the V-shaped linear grooves on said section of said top surface or against any capillary tubes present in or on said V-shaped linear grooves.

2. The capillary tube holder of claim 1, wherein said holder body further comprises additional mating elements on the bottom surface thereof.

3. The capillary tube holder of claim 1, wherein said front side of said holder body has a detent groove therein, running perpendicular to said flank sides.

4. The capillary tube holder of claim 1, wherein said mating elements on the flank sides of said holder body are tapered mating elements, disposed perpendicularly from the top surface and tapering increasingly further away from the flank sides along the direction from the top surface towards the bottom surface.

5. The capillary tube holder of claim 1, wherein said compression element of said holder clip is an elastomeric insert.

6. The capillary tube holder of claim 5, wherein the elastomer of said elastomeric insert has a Shore A durometer hardness of greater than 40 and less than 60.

7. The capillary tube holder of claim 6, wherein said Shore A durometer hardness is between 45 and 55.

8. The capillary tube holder of claim 5, wherein the elastomer of said elastomeric insert is a platinum cured silicone rubber.

9. The capillary tube holder of claim 5, wherein said elastomeric element is a rubber gasket.

10. The capillary tube holder of claim 9, wherein the rubber of said rubber gasket is a butadiene-acrylonitrile rubber.

11. The capillary tube holder of claim 5, wherein said compression element has a rectangular cross-section.

12. The capillary tube holder of claim 1, wherein said mating elements (22) of said side arms (21), said mating elements (9) on said holder body and said compression element are disposed in relationship to each other, and the Shore A hardness of said compression element selected at a value whereby said mating elements (22) of said arms (21) engage with said mating elements (9) of said holder body to compress said compression element against any capillary tubes present in said groves with a force sufficient to prevent movement of said tubes in said groves until a movement initiating force of between 0.04 and 3.0 Newtons is applied directly to said tubes along the tube axis to said tubes to begin movement of said tubes in said grooves, and a sliding force of between 0.04 to 2.8 Newtons is applied to maintain said movement.

13. A container for the capillary tube holder of claim 2, comprising a box (85) having a top wall, a bottom wall, two side walls a front end and a rear wall which define the interior of said box, the interior surface of said bottom wall being provided with mating elements (81) which are complementary to the mating elements on the bottom surface of capillary tube holder body 1, the top wall having a hinged section which is integral with a front wall for said box, and which in the open position exposes said mating elements for insertion of said capillary tube holder thereon from the top to engage the mating elements of said tube holder body with the mating elements on the interior surface of said bottom wall of said box, and for withdrawal of any capillary tubes mounted on said holder from the front, and being closable to bring said front wall into contact with said bottom wall at the front end of said container, and enclose said capillary tube holder, and any capillary tubes mounted thereon, within said box.

14. The container of claim 13, wherein said hinged section is transparent.

15. The container of claim 13 wherein, between the hinges of said hinged section and the front side of said container said sidewalls are comprised of two sections, a first section extending from said bottom surface and a second section extending from said hinged section of said top wall, said two sections meeting each other upon closure of said hinged section.

16. The container of claim 13, wherein said first sections of said sidewalls have either a bump or a hole, and said second sections have the other of a bump or a hole, said bumps and holes being complementary to and engagable with each other to secure said hinged section in a closed position.

17. The container of claim 13 wherein said container is formed of a front section and a rear section which are engagable with each other to form the container, said front section comprising said mating elements 81 and said hinged section of said top wall, said rear section having a length which is defined in accordance with the length of capillary tubes to be mounted on said holder body and enclosed by said box.

18. The container of claim 13 wherein the bottom of said container has an inwardly extending indentation which aligns with the hinge in the top wall of a second said container when two of said containers are stacked one on top of the other.

19. A loading fixture for loading capillary tubes onto a capillary tube holder of claim 1, comprising an alignment fixture (30), loading mount (40) and loading clip (50), wherein
a) said alignment fixture (30) comprises a body having a front side, a rear side and a top surface, at least one magnet (32) located on said top surface, and an upward protrusion projecting from said top surface at the rear side thereof, said protrusion having an inwardly facing flat surface (34) forming an approximately 90° angle with said top surface,
b) said loading mount (40) comprises a body having a top surface, a bottom surface, a front side, a rear side (43) and two flank sides, with at least one magnet (42) mounted in said body and being exposed at or through said top surface and said bottom surface and being disposed to align with said at least one magnet (32) on said alignment fixture, said loading mount (40) having an elevated section having an upwardly stepped edge (41) on the top surface thereof adjacent the rear side, said upwardly stepped edge (41) facing the front side of said loading mount (40),
c) said loading clip (50) having a top side, bottom side, two ends and a planar rear face (55), with two side arms projecting from said bottom side at said ends, at an approximately 90° angle from said bottom side, each side arm terminating in a side arm end having a magnet (53) affixed thereto, an elastomeric insert 54 held against said rear face (55) by a pressure clamp (52) and projecting beyond the bottom side of said loading clip 50, the plane of said rear face (55) forming an acute angle with an axis passing through said side arms from the bottom of said loading clip to the side arm ends.

20. The loading fixture of claim 19, wherein said at least one magnet mounted in said body is two magnets, and said at least one magnet of said alignment fixture is two magnets.

21. The loading fixture of claim 19, wherein said planar rear face of said loading clip has two threaded holes therein adjacent the ends thereof, and said pressure clamp has two holes aligned with said holes in said planar rear face of said loading clip whereby said pressure clamp is attached to said planer rear face by screws, to hold said elastic insert against said planar rear face.

22. The loading fixture of claim 19, wherein said elastic insert has an approximately rectangular shape and an approximately flat edge on the portion projecting beyond the bottom side of said loading clip.

23. The loading fixture of claim 19, wherein when a capillary tube holder body having a V-shaped linearly grooved surface the groves of which have two open ends is placed on mount (40) and loading clip (50) is placed over said holder body on said mount, said loading clip magnets (53) are brought into alignment with and magnetically attached to said at least one magnet (42) of loading mount (40) to bring the projecting part of said elastomeric insert (54) of loading clip (50) into angular contact with said grooved surface of said holder body, said projecting part of said elastomeric insert (54) imparts a resistance to the insertion of capillary tubes into said V-shaped linear grooves that will require a force of less than one Newton to initiate movement of said capillary tubes into said grooves, and a force of less than 0.04 Newton up to about 0.2 Newton to maintain said movement of said capillary tubes into said grooves.

24. A method of loading capillary tubes into a capillary tube holder, which comprises:
a) placing loading mount (40) of claim 19 on an alignment fixture (30) of claim 19, with rear side (43) of loading mount (40) abutting the inwardly facing flat surface of the upward protrusion of alignment fixture (30), and bringing the at least one magnet (42) of loading mount (40) into alignment with and magnetic attachment to the at least one magnet (32) of alignment fixture (30) to hold loading mount (40) to alignment fixture (30),
b) placing a holder body (1) of claim 1 on mount (40) with rear face (13) of holder body (1) abutting the upwardly stepped edge (41) of said elevated section of loading mount (40),
c) placing loading clip (50) of claim 19 over holder body (1) on mount (40) and bringing the loading clip magnets (53) into alignment with and magnetic attachment to the at least one magnet (42) of loading mount (40) to bring the projecting portion of the elastomeric insert (54) of loading clip (50) into angular contact with a portion of said grooved surface of said holder body (1), or with any capillary tubes (91) that are present in or on said grooves,
d) inserting one or more capillary tubes in the grooves of holder body (1) by sliding said capillary tubes between said grooves and said elastic insert (54) of said loading clip (50),
e) placing the holding clip (20) of claim 1 over said grooved surface of holder body (1) and engaging mating elements (22) of said holding clip with the mating elements on the sides of holder body (1) to compress said compression element of said holding clip (20) against said capillary tubes (91) in said grooves,
f) removing loading clip (50) from said mount (40), and removing said holder body (1), with tubes (91) thereon, from said mount (40).

25. A transfer carrier, for transferring or removing a group of tubes from a holder body (1) on which said tubes are held by a holding clip (20) in alignment with respect to each other, while maintaining said alignment, comprising a carrier body (60) and carrier clip (70), said carrier body having a front, a rear, two sides and a top surface (68), a plurality of V-shaped linear grooves-(64) in said top surface said grooves being open ended at said top surface and no part of which are curved, running in the direction from the front to the rear, and an opening (65) through said carrier body, adjacent the rear and configured to receive a holder body (1), securing elements for removably securing said holder body within said opening, said opening having sufficient interior clearance for said holder body (1) and holding clip (20) to pass through said opening upon application of sufficient force to release said holder body (1) from said securing elements.

26. The transfer carrier of claim 25, further comprising a slot (61) through the rear thereof adapted to receive at least one projection (5) extending from a side of a holder body (1) of a capillary tube holder.

27. The transfer carrier of claim 25, wherein said securing elements are compressive elements (63).

28. The transfer carrier of claim 27, wherein said compressive elements are spring loaded pins.

29. The transfer carrier of claim 28, wherein said spring loaded pins are adapted to interface into a detent in a face of a holder body (1) of a capillary tube holder.

30. The transfer carrier of claim 25, wherein a portion of the top surface, beginning at the front of said transfer adjacent the front of said carrier, adjacent the part of the opening closest to the front of said transfer carrier, or both, is stepped down to a level equal to or lower than the bottom of said V-shaped linear grooves.

31. The transfer carrier of claim 25, wherein said carrier clip (70) comprises a body having a top side and a bottom side with two side arms projecting from the bottom side, and a compression element or insert on the surface of the bottom side of said body.

32. The transfer carrier of claim 31, wherein the side arms of said carrier clip (70) and the sides of said carrier body comprise interlocking complementary mating elements.
